(19) United States
(12) Patent Application Publication
(10) Pub. No.: US 2007/0069845 A1
(43) Pub. Date: Mar. 29, 2007

(54) Ignition coil for a gasoline engine

(76) Inventors: Markus Weimert, Immenstadt (DE); Tim Skowronek, Missen-Wilhams (DE)

Correspondence Address: KENYON & KENYON LLP, ONE BROADWAY, NEW YORK, NY, 10004, US

(21) Appl. No.: 10/573,608

(22) PCT Filed: Sep. 10, 2004
(86) PCT No.: PCT/EP04/52122

§ 371 Date: Dec. 4, 2006

(30) Foreign Application Priority Data
Sep. 26, 2003 (DE) 103-44-891.8

(51) Int. Cl. H01F 17/04; H01F 27/28

(52) U.S. Cl. 336/221; 336/225

(57) ABSTRACT

Described is an ignition coil for a gasoline engine having a coil core in which a primary magnetic field is inducible via a current-carrying, essentially coil-shaped primary winding. The ignition coil has an essentially coil-shaped secondary winding, in which an energy field, which controls at least one spark plug, is able to be built up due to the primary magnetic field. A premagnetization device for forming a premagnetization field opposite the primary magnetic field is effective at the coil core. The premagnetization device has a current-carrying, essentially coil-shaped premagnetization winding.

### BACKGROUND INFORMATION

The present invention relates to an ignition coil for a gasoline engine according to the definition of the species in claim 1.

Such an ignition coil represents a power-transmitting high voltage source and is used in a gasoline engine for controlling the spark plug, which in turn ignites the fuel mixture in the engine's combustion chamber, thereby initiating the movement of the piston and thus the crank shaft.

The function principle of such an ignition coil is also known under the term “inductive ignition” or “battery ignition” and is used today in almost all externally ignited fuel engines.

The storable magnetic energy is essential for the ignition coil and depends on the configuration of its magnetic core and its material properties. As a rule, the magnetic core is made of a ferromagnetic material and is generally referred to as an “iron core.” The iron core is typically made up of a laminated core or is designed as a metal powder core. Since, in certain designs, the iron core does not continuously enclose the winding, but has gaps which are also referred to as air gaps, it is also referred to as a “gapped” iron core.

During controlling of the ignition coil by an engine control unit, magnetic energy is stored in the ignition coil due to the rising primary current. The energy increase does not arbitrarily continue with the current increase, but is rather limited by the saturation flux density of the iron core. This means that, along with the increasing current, the material of the iron core may not be further magnetized. The material is magnetically saturated. This connection is also expressed by the hysteresis curve of the iron core.

In order to counteract these physical factors, a normal measure, known from practice, is to integrate a permanent magnet into the iron core. Such a permanent magnet or multiple such permanent magnets is/are integrated into the magnetic core in such a way that the direction of the flux density is opposite the exciting field of the current-carrying winding. This is also known as “premagnetization,” since in the passive state, in which no electrical current flows, a magnetic flow already prevails in the iron core.

This premagnetization makes it possible to delay the magnetic saturation of the iron core, based on the level of the primary current, so that overall more magnetic energy may be stored in the ignition coil. This is a measure for energy optimization of ignition coils commonly used in practice.

In compact coils, typically a single permanent magnet is integrated into the iron core, whereas in bar coils preferably two permanent magnets at each end of the bar core are integrated into the iron core.

It is a disadvantage in conventional ignition coils that the permanent magnet(s) must be installed in the iron core at a significant production cost. In bar coils it is particularly important that the edges of the magnets are correspondingly rounded prior to installation, in order to counteract the danger of electric breakdowns. In addition, attention must be paid to the polarity of the magnet(s), since a wrong polarity is counterproductive to the intended effect of energy storage.

Furthermore, permanent magnets are temperature-dependent so that high flow-through and simultaneous high temperatures may result in the demagnetization of a permanent magnet. Such a demagnetization represents an irreversible process.

The properties of a permanent magnet are primarily determined by its material and the geometry of the configuration. If a permanent magnet is installed in a conventional ignition coil, its properties are no longer able to be modified in a targeted manner. If, for example, the same ignition coil is to be used in a different engine, which requires different parameters of the ignition coil, the energy optimization of the ignition coil may need to be modified. The energy optimization of the ignition coil is adjusted via premagnetization. For this purpose, the permanent magnet must be exchanged and replaced by a magnet having a possibly modified geometry.

However, the latter disadvantageously requires constructive retrofitting of the ignition coil.

The object of the present invention is to provide an ignition coil for a gasoline engine in which the energy optimization is possible by adapting the premagnetization of the iron core without simultaneous constructive retrofitting.

Moreover, permanent magnets for premagnetization of the iron core are not be used in the ignition coil according to the present invention, thereby reducing the production cost associated with the inefficient handling of such permanent magnets.

### ADVANTAGES OF THE INVENTION

If in an ignition coil for a gasoline engine of the above-mentioned type, i.e., having a coil core, in which a primary magnetic field is inducible via a current-carrying, essentially coil-shaped primary winding, and an essentially coil-shaped secondary winding, in which, due to the primary magnetic field, an energy field, which controls at least one spark plug, is able to be built, a premagnetization device for forming a premagnetization field opposite the primary magnetic field being effective at the coil core, the premagnetization device having a current-carrying, essentially coil-shaped premagnetization winding, a premagnetization may advantageously be achieved with the aid of a corresponding electric current via the premagnetization winding.

Accordingly, no permanent magnet must be taken into account in the constructive configuration of the iron core and also no different magnet geometries must be taken into account in other applications of the ignition coil.

Due to the omission of the permanent magnets, the bar core may be correspondingly extended, in bar coils in particular, which offers further advantages in energy optimization. In this case, the winding length is advantageously allowed to increase, particularly since windings, which are situated over permanent magnets, are physically hardly effective.

Conversely, the premagnetization winding may represent the only possibility of energy optimization, since in the event of a required maximum length of the bar core, there may no longer be any space for a permanent magnet.

In addition, the premagnetization via an auxiliary winding is flexible, i.e., besides the field direction, the magnetic field strength may also be freely selected via a corresponding control under optimal utilization of the core material.

By including the premagnetization winding, which does not have limiting properties like a permanent magnet, the premagnetization flux density may be increased up to the saturation polarization of the core material.

This advantage is also true for a compact coil, since the core material may conventionally be optimally used only if a permanent-magnet having a large surface is integrated into the magnetic core. In addition to high costs, this also results in great space requirements.

Due to the premagnetization winding, the ignition coil according to the present invention is very flexible with regard to its energy yield and does not require constructive modifications. Primarily with regard to space problems in the axial direction, the design of an ignition coil according to the present invention represents an advantageous alternative to permanent magnets.

Depending on the design possibility of the premagnetization winding, this ignition coil may also have a price advantage compared to the use of permanent magnets.

In order to achieve the best possible premagnetization effect, the primary winding and the premagnetization winding are wound around the coil core essentially parallel to one another. The current flow directions of the electric current in adjoining turns of the primary winding and the premagnetization winding should be oriented in an anti-parallel manner.

In order to achieve a preferably free control of the premagnetization winding, the current supply connections of the primary winding and the premagnetization winding may be designed to be separate from one another.

As an alternative, the primary winding and the premagnetization winding may also be controlled together and have a common current supply connection. It may be advantageous here, if a series resistor is connected between the current supply connection and the premagnetization winding.

Depending on the embodiment of the control, the premagnetization winding may be controlled either permanently or temporarily, thereby generating a magnetic field which counteracts the exciting field of the primary winding, causing the premagnetization effect.

In a suitable current control, premagnetization via an additional winding according to the present invention is temperature-independent.

The end of the premagnetization winding, opposite the current supply connection, may be connected to ground in a particularly simple embodiment of an ignition coil according to the present invention.

A particularly advantageous configuration from a production standpoint may be achieved in that the primary winding and the premagnetization winding are wound up on the coil core as a single multi-layer winding, the multi-layer winding being cut at least at one point for separating the primary winding and the premagnetization winding and the free ends being contacted for connecting purposes. This has the advantage from a production standpoint that an additional process step is not required.

### DRAWING

An exemplary embodiment of the present invention is illustrated in the drawing and explained in greater detail in the subsequent description.

FIG. 1 shows a simplified schematic side view of an ignition coil according to the present invention in which a primary winding and a premagnetization winding are represented;

FIG. 2 shows a schematic diagram of an ignition system including a separate control of the premagnetization winding of an ignition coil according to FIG. 1, and

FIG. 3 shows a schematic diagram of an ignition system including a common control of the primary winding and the premagnetization winding of an ignition coil.

### DESCRIPTION OF THE EXEMPLARY EMBODIMENT

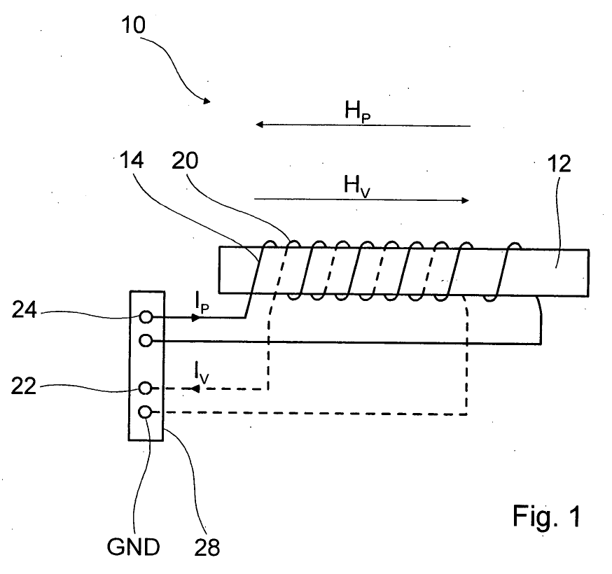

FIG. 1 shows a simplified schematic side view of an ignition coil 10 for a gasoline engine of a motor vehicle in which a primary winding 14 and a premagnetization winding 20 are represented. Another secondary winding is implemented in a known manner and is not shown in greater detail in FIG. 1.

Primary winding 14 is made up of an electrically conductive, insulated wire which is wound up on a bar core 12, the wire being wound up from a left end of bar core 12 in FIG. 1 to a right end of bar core 12 in FIG. 1.

The secondary winding (not shown) of ignition coil 10 in which an energy field is induced by a magnetic field H_{P}, generated on the primary side, is attached in an electrically insulated manner adjacent to primary winding 14.

Premagnetization winding 20, shown in FIG. 1 in a dashed line, represents a completely separate winding in the shown embodiment. The electrically conductive, insulated wire of premagnetization winding 20 is wound up from a left end of bar core 12 in FIG. 1 to a right end of bar core 12 in FIG. 1, the wire of premagnetization winding 20 being placed in the gap between the individual turns of primary winding 14 over almost the complete extension area of the windings. Premagnetization winding 20 and primary winding 14 are thus wound in parallel over the better part of the length of bar core 12.

Current flow I_{V} in one winding of premagnetization winding 20 and current flow I_{P} in an adjacent winding of primary winding 14 are anti-parallel, so that the magnetic fields building up, a premagnetization field H_{V} and primary-side magnetic field H_{P}, also have an anti-parallel orientation. This orientation yields the intended “premagnetization effect.”

In the embodiment according to FIG. 1, a connection 24 for feeding an electric current I_{P} into primary winding 14 is situated separately from a connection 22 for feeding an electric current I_{V} into premagnetization winding 20. It is possible to guide both connections 22 and 24 separately via a common connector 28 onto a wiring harness of a motor vehicle.

In an alternative embodiment, premagnetization winding 20 may also be integrated into primary winding 14. During manufacture of such an “integrated” premagnetization winding 20, more primary turns than necessary are wound up on bar core 12 in a single wind-up process. Primary winding 14 as well as premagnetization winding 20 are subsequently separated from the contiguously applied winding via corresponding cutting and contacting of the respective wire ends. Connections 22 and 24 of primary winding 14 and premagnetization winding 20 may again be separately guided via a common connector 28 onto a wiring harness of a motor vehicle.

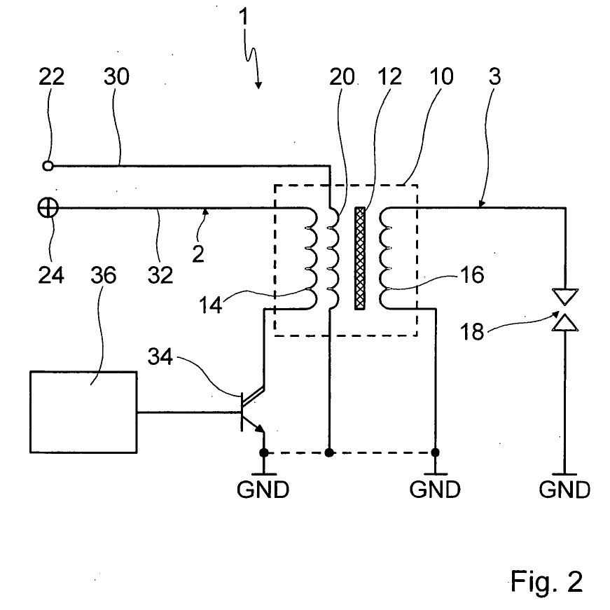

FIG. 2 shows a schematic diagram of an ignition system 1 including a separate control of premagnetization winding 20 in an ignition coil 10 according to the present invention for a gasoline engine, ignition coil 10, as shown in FIG. 1, having a coil core 12 on which primary winding 14 and premagnetization winding 20 are wound up.

A separate premagnetization winding control line 30 is run from current connection 22, connected to the wire harness of the motor vehicle (not shown), to one end of premagnetization winding 20 of ignition coil 10. The other winding end of premagnetization winding 20 is connected to ground GND.

In a primary circuit 2 of ignition system 1, representing a control circuit, a separate primary winding control line 32, which may also be connected at primary-side current connection 24 to the wire harness of the motor vehicle (not shown), is run to one end of primary winding 14 of ignition coil 10. The other end of primary winding 14 is connected to a transistor 34. This transistor is controlled at the base via an engine management 36 of the gasoline engine.

Secondary winding 16 of ignition coil 10, which also surrounds coil core 12, is part of a secondary circuit 3, forming an ignition circuit, in that the winding's one end contacts, in a known manner, a spark plug 18 of a gasoline engine which is connected to ground GND.

In particular due to the fact that premagnetization field H_{V} does not have to be present permanently, such a separate control of premagnetization winding 20 of ignition coil 10 is practicable.

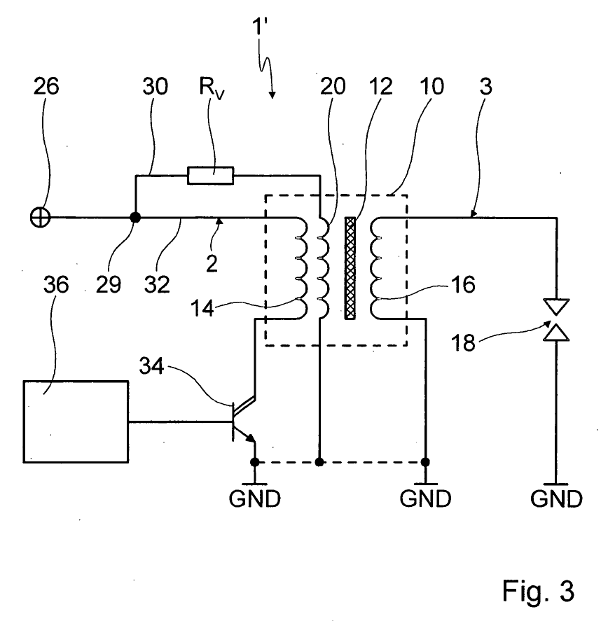

FIG. 3 shows a schematic diagram of an ignition system 1′ including a common control of primary winding 14 and premagnetization winding 20.

In this embodiment as in ignition system 1 of FIG. 2, primary winding control line 32 runs in the primary circuit from a current connection 26 at a wire harness of the motor vehicle (not shown) to one end of primary winding 14 of ignition coil 10. The other end of primary winding 14 is connected to a transistor 34 which is controlled at the base via engine management 36 of the gasoline engine.

A premagnetization winding control line 30 is connected to current connection 26 of primary winding control line 32, premagnetization winding control line 30 branching from primary winding control line 32 at a connection point 29 and running via a series resistor R_{V} to one end of premagnetization winding 20 of ignition coil 10 which is wound up on coil core 12. The other winding end of premagnetization winding 20 is connected to ground GND.

The configuration of secondary winding 14 of ignition coil 10 and the combination of secondary circuit 3 with a spark plug 18 of a gasoline engine corresponds incidentally to the embodiment according to FIG. 2.

Further variants of the control are alternatively conceivable. It is important in each case to build up a premagnetization field H_{V}, which is anti-parallel to primary field H_{P}, in order to achieve energy optimization via adaptation of the premagnetization of the iron core.

### FIELD OF THE INVENTION

The present invention relates to an ignition coil for a gasoline engine.

### BACKGROUND INFORMATION

Such an ignition coil represents a power-transmitting high voltage source and is used in a gasoline engine for controlling the spark plug, which in turn ignites the fuel mixture in the engine's combustion chamber, thereby initiating the movement of the piston and thus the crank shaft.

The function principle of such an ignition coil is also known under the term “inductive ignition” or “battery ignition” and is used today in almost all externally ignited fuel engines.

The storable magnetic energy is essential for the ignition coil and depends on the configuration of its magnetic core and its material properties. As a rule, the magnetic core is made of a ferromagnetic material and is generally referred to as an “iron core.” The iron core is typically made up of a laminated core or is designed as a metal powder core. Since, in certain designs, the iron core does not continuously enclose the winding, but has gaps which are also referred to as air gaps, it is also referred to as a “gapped” iron core.

During controlling of the ignition coil by an engine control unit, magnetic energy is stored in the ignition coil due to the rising primary current. The energy increase does not arbitrarily continue with the current increase, but is rather limited by the saturation flux density of the iron core. This means that, along with the increasing current, the material of the iron core may not be further magnetized. The material is magnetically saturated. This connection is also expressed by the hysteresis curve of the iron core.

In order to counteract these physical factors, a normal measure, known from practice, is to integrate a permanent magnet into the iron core. Such a permanent magnet or multiple such permanent magnets is/are integrated into the magnetic core in such a way that the direction of the flux density is opposite the exciting field of the current-carrying winding. This is also known as “premagnetization,” since in the passive state, in which no electrical current flows, a magnetic flow already prevails in the iron core.

This premagnetization makes it possible to delay the magnetic saturation of the iron core, based on the level of the primary current, so that overall more magnetic energy may be stored in the ignition coil. This is a measure for energy optimization of ignition coils commonly used in practice.

In compact coils, typically a single permanent magnet is integrated into the iron core, whereas in bar coils preferably two permanent magnets at each end of the bar core are integrated into the iron core.

It is a disadvantage in conventional ignition coils that the permanent magnet(s) must be installed in the iron core at a significant production cost. In bar coils it is particularly important that the edges of the magnets are correspondingly rounded prior to installation, in order to counteract the danger of electric breakdowns. In addition, attention must be paid to the polarity of the magnet(s), since a wrong polarity is counterproductive to the intended effect of energy storage.

Furthermore, permanent magnets are temperature-dependent so that high flow-through and simultaneous high temperatures may result in the demagnetization of a permanent magnet. Such a demagnetization represents an irreversible process.

The properties of a permanent magnet are primarily determined by its material and the geometry of the configuration. If a permanent magnet is installed in a conventional ignition coil, its properties are no longer able to be modified in a targeted manner. If, for example, the same ignition coil is to be used in a different engine, which requires different parameters of the ignition coil, the energy optimization of the ignition coil may need to be modified. The energy optimization of the ignition coil is adjusted via premagnetization. For this purpose, the permanent magnet must be exchanged and replaced by a magnet having a possibly modified geometry.

However, the latter disadvantageously requires constructive retrofitting of the ignition coil.

### SUMMARY OF THE INVENTION

The object of the present invention is to provide an ignition coil for a gasoline engine in which the energy optimization is possible by adapting the premagnetization of the iron core without simultaneous constructive retrofitting.

Moreover, permanent magnets for premagnetization of the iron core are not be used in the ignition coil according to the present invention, thereby reducing the production cost associated with the inefficient handling of such permanent magnets.

### ADVANTAGES OF THE INVENTION

If in an ignition coil for a gasoline engine of the above-mentioned type, i.e., having a coil core, in which a primary magnetic field is inducible via a current-carrying, essentially coil-shaped primary winding, and an essentially coil-shaped secondary winding, in which, due to the primary magnetic field, an energy field, which controls at least one spark plug, is able to be built, a premagnetization device for forming a premagnetization field opposite the primary magnetic field being effective at the coil core, the premagnetization device having a current-carrying, essentially coil-shaped premagnetization winding, a premagnetization may advantageously be achieved with the aid of a corresponding electric current via the premagnetization winding.

Accordingly, no permanent magnet must be taken into account in the constructive configuration of the iron core and also no different magnet geometries must be taken into account in other applications of the ignition coil.

Due to the omission of the permanent magnets, the bar core may be correspondingly extended, in bar coils in particular, which offers further advantages in energy optimization. In this case, the winding length is advantageously allowed to increase, particularly since windings, which are situated over permanent magnets, are physically hardly effective.

Conversely, the premagnetization winding may represent the only possibility of energy optimization, since in the event of a required maximum length of the bar core, there may no longer be any space for a permanent magnet.

In addition, the premagnetization via an auxiliary winding is flexible, i.e., besides the field direction, the magnetic field strength may also be freely selected via a corresponding control under optimal utilization of the core material.

By including the premagnetization winding, which does not have limiting properties like a permanent magnet, the premagnetization flux density may be increased up to the saturation polarization of the core material.

This advantage is also true for a compact coil, since the core material may conventionally be optimally used only if a permanent magnet having a large surface is integrated into the magnetic core. In addition to high costs, this also results in great space requirements.

Due to the premagnetization winding, the ignition coil according to the present invention is very flexible with regard to its energy yield and does not require constructive modifications. Primarily with regard to space problems in the axial direction, the design of an ignition coil according to the present invention represents an advantageous alternative to permanent magnets.

Depending on the design possibility of the premagnetization winding, this ignition coil may also have a price advantage compared to the use of permanent magnets.

In order to achieve the best possible premagnetization effect, the primary winding and the premagnetization winding are wound around the coil core essentially parallel to one another. The current flow directions of the electric current in adjoining turns of the primary winding and the premagnetization winding should be oriented in an anti-parallel manner.

In order to achieve a preferably free control of the premagnetization winding, the current supply connections of the primary winding and the premagnetization winding may be designed to be separate from one another.

As an alternative, the primary winding and the premagnetization winding may also be controlled together and have a common current supply connection. It may be advantageous here, if a series resistor is connected between the current supply connection and the premagnetization winding.

Depending on the embodiment of the control, the premagnetization winding may be controlled either permanently or temporarily, thereby generating a magnetic field which counteracts the exciting field of the primary winding, causing the premagnetization effect.

In a suitable current control, premagnetization via an additional winding according to the present invention is temperature-independent.

The end of the premagnetization winding, opposite the current supply connection, may be connected to ground in a particularly simple embodiment of an ignition coil according to the present invention.

A particularly advantageous configuration from a production standpoint may be achieved in that the primary winding and the premagnetization winding are wound up on the coil core as a single multi-layer winding, the multi-layer winding being cut at least at one point for separating the primary winding and the premagnetization winding and the free ends being contacted for connecting purposes. This has the advantage from a production standpoint that an additional process step is not required.

### BRIEF DESCRIPTION OF THE DRAWINGS

FIG. 1 shows a simplified schematic side view of an ignition coil according to the present invention in which a primary winding and a premagnetization winding are represented.

FIG. 2 shows a schematic diagram of an ignition system including a separate control of the premagnetization winding of an ignition coil according to FIG. 1.

FIG. 3 shows a schematic diagram of an ignition system including a common control of the primary winding and the premagnetization winding of an ignition coil.

### DETAILED DESCRIPTION

FIG. 1 shows a simplified schematic side view of an ignition coil 10 for a gasoline engine of a motor vehicle in which a primary winding 14 and a premagnetization winding 20 are represented. Another secondary winding is implemented in a known manner and is not shown in greater detail in FIG. 1.

Primary winding 14 is made up of an electrically conductive, insulated wire which is wound up on a bar core 12, the wire being wound up from a left end of bar core 12 in FIG. 1 to a right end of bar core 12 in FIG. 1.

The secondary winding (not shown) of ignition coil 10 in which an energy field is induced by a magnetic field H_{P}, generated on the primary side, is attached in an electrically insulated manner adjacent to primary winding 14.

Premagnetization winding 20, shown in FIG. 1 in a dashed line, represents a completely separate winding in the shown embodiment. The electrically conductive, insulated wire of premagnetization winding 20 is wound up from a left end of bar core 12 in FIG. 1 to a right end of bar core 12 in FIG. 1, the wire of premagnetization winding 20 being placed in the gap between the individual turns of primary winding 14 over almost the complete extension area of the windings. Premagnetization winding 20 and primary winding 14 are thus wound in parallel over the better part of the length of bar core 12.

Current flow I_{V} in one winding of premagnetization winding 20 and current flow I_{P} in an adjacent winding of primary winding 14 are anti-parallel, so that the magnetic fields building up, a premagnetization field H_{V} and primary-side magnetic field H_{P}, also have an anti-parallel orientation. This orientation yields the intended “premagnetization effect.”

In the embodiment according to FIG. 1, a connection 24 for feeding an electric current I_{P} into primary winding 14 is situated separately from a connection 22 for feeding an electric current I_{V} into premagnetization winding 20. It is possible to guide both connections 22 and 24 separately via a common connector 28 onto a wiring harness of a motor vehicle.

In an alternative embodiment, premagnetization winding 20 may also be integrated into primary winding 14. During manufacture of such an “integrated” premagnetization winding 20, more primary turns than necessary are wound up on bar core 12 in a single wind-up process. Primary winding 14 as well as premagnetization winding 20 are subsequently separated from the contiguously applied winding via corresponding cutting and contacting of the respective wire ends. Connections 22 and 24 of primary winding 14 and premagnetization winding 20 may again be separately guided via a common connector 28 onto a wiring harness of a motor vehicle.

FIG. 2 shows a schematic diagram of an ignition system 1 including a separate control of premagnetization winding 20 in an ignition coil 10 according to the present invention for a gasoline engine, ignition coil 10, as shown in FIG. 1, having a coil core 12 on which primary winding 14 and premagnetization winding 20 are wound up.

A separate premagnetization winding control line 30 is run from current connection 22, connected to the wire harness of the motor vehicle (not shown), to one end of premagnetization winding 20 of ignition coil 10. The other winding end of premagnetization winding 20 is connected to ground GND.

In a primary circuit 2 of ignition system 1, representing a control circuit, a separate primary winding control line 32, which may also be connected at primary-side current connection 24 to the wire harness of the motor vehicle (not shown), is run to one end of primary winding 14 of ignition coil 10. The other end of primary winding 14 is connected to a transistor 34. This transistor is controlled at the base via an engine management 36 of the gasoline engine.

Secondary winding 16 of ignition coil 10, which also surrounds coil core 12, is part of a secondary circuit 3, forming an ignition circuit, in that the winding's one end contacts, in a known manner, a spark plug 18 of a gasoline engine which is connected to ground GND.

In particular due to the fact that premagnetization field H_{V} does not have to be present permanently, such a separate control of premagnetization winding 20 of ignition coil 10 is practicable.

FIG. 3 shows a schematic diagram of an ignition system 1′ including a common control of primary winding 14 and premagnetization winding 20.

In this embodiment as in ignition system 1 of FIG. 2, primary winding control line 32 runs in the primary circuit from a current connection 26 at a wire harness of the motor vehicle (not shown) to one end of primary winding 14 of ignition coil 10. The other end of primary winding 14 is connected to a transistor 34 which is controlled at the base via engine management 36 of the gasoline engine.

A premagnetization winding control line 30 is connected to current connection 26 of primary winding control line 32, premagnetization winding control line 30 branching from primary winding control line 32 at a connection point 29 and running via a series resistor R_{V} to one end of premagnetization winding 20 of ignition coil 10 which is wound up on coil core 12. The other winding end of premagnetization winding 20 is connected to ground GND.

The configuration of secondary winding 14 of ignition coil 10 and the combination of secondary circuit 3 with a spark plug 18 of a gasoline engine corresponds incidentally to the embodiment according to FIG. 2.

Further variants of the control are alternatively conceivable. It is important in each case to build up a premagnetization field H_{V}, which is anti-parallel to primary field H_{P}, in order to achieve energy optimization via adaptation of the premagnetization of the iron core.

1-8. (canceled)

9. An ignition coil for a gasoline engine, comprising:
a current-carrying, substantially coil-shaped primary winding;
a coil core in which a primary magnetic field is inducible via the primary winding;
a substantially coil-shaped secondary winding in which an energy field that controls at least one spark plug is able to be built up due to the primary magnetic field; and
a premagnetization device for forming a premagnetization field opposite the primary magnetic field and being effective at the coil core, wherein the premagnetization device includes a current-carrying, substantially coil-shaped premagnetization winding.

10. The ignition coil as recited in claim 9, wherein the primary winding and the premagnetization winding are wound around the coil core substantially parallel to one another.

11. The ignition coil as recited in claim 9, wherein current flow directions of electric currents in adjoining turns of the primary winding and the premagnetization winding are oriented in an anti-parallel manner.

12. The ignition coil as recited in claim 9, wherein current supply connections of the primary winding and the premagnetization winding are separate from one another.

13. The ignition coil as recited in claim 9, wherein the primary winding and the premagnetization winding have a common current supply connection.

14. The ignition coil as recited in claim 13, further comprising:
a series resistor connected between the current supply connection and the premagnetization winding.

15. The ignition coil as recited in claim 14, wherein an end of the premagnetization winding opposite the current supply connection is connected to a ground.

16. The ignition coil as recited in claim 9, wherein:
the primary winding and the premagnetization winding are wound up on the coil core as a single multi-layer winding,
the multi-layer winding is cut at least at one point for separating the primary winding and the premagnetization winding, and
the free ends are contacted for a connecting purpose.
